(19) United States
(12) Patent Application Publication
(10) Pub. No.: US 2012/0188594 A1
(43) Pub. Date: Jul. 26, 2012

(54) Print Job Management Mechanism

(76) Inventors: Robert F. Jessen, Berthoud, CO (US); Philip K. Cihiwsky, Loveland, CO (US); Dean O. Miller, Littleton, CO (US); Jeffrey A. Sikkink, Longmont, CO (US)

(21) Appl. No.: 13/013,250

(22) Filed: Jan. 25, 2011

(51) Int. Cl. G06F 3/12

(52) U.S. Cl. 358/1.15

(57) ABSTRACT

A printing system is disclosed. The printing system includes a storage device and a print job manager to store received print jobs in the storage device, select one or more of the stored print jobs upon detecting an occurrence of a condition that matches one or more pre-defined criteria and performing a processing action indicated by the pre-defined criteria.

### FIELD OF THE INVENTION

The invention relates to the field of printing systems, and in particular, to the management of print jobs produced at a printing system.

### BACKGROUND

Computing centers that employ one or more printers to serve a group of users, such as a networked group or other work group, typically rely on the printers to batch process print jobs (e.g., print-out a series of different print jobs in succession). Such printers produce separator pages which are used for identification and segregation of print jobs in an office, departmental or other shared or multi-user printing environment. Separator pages generated at the beginning of a print job are commonly referred to as headers, while pages generated after a print job are referred to as trailers. Such separator pages include one or two lines of text that identify the requesting party and identify the job number.

Separator pages have an undesirable characteristic in that they are printed with associated printing costs, and are not environmentally friendly. For example, separator pages have very little value after the user retrieves their print job, and are in many instances not recycled. Since there is typically one per print job, separator pages are particularly wasteful for smaller print jobs on a per print job page basis. Printers for groups often have additional issues such as wasteful usage, output security, and priority conflicts.

Accordingly, a mechanism to manage print jobs including the generation of separator pages and enforcement of print policies is desired.

### SUMMARY

In one embodiment a printing system is disclosed. The printing system includes a storage device and a print job manager to store received print jobs in the storage device, select one or more of the stored print jobs upon detecting an occurrence of a condition that matches one or more pre-defined criteria and performing a processing action indicated by the pre-defined criteria.

In another embodiment, a computer generated method discloses, receiving a print job, storing the print job data, determining if a condition occurs during that matches one or more pre-defined criteria, selecting the print job if the condition occurs and performing a processing action indicated by the pre-defined criteria.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 is a flow diagram illustrating one embodiment of managing print jobs within a printing system; and

FIG. 3 illustrates one embodiment of a computer system.

### DETAILED DESCRIPTION

A print job management mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

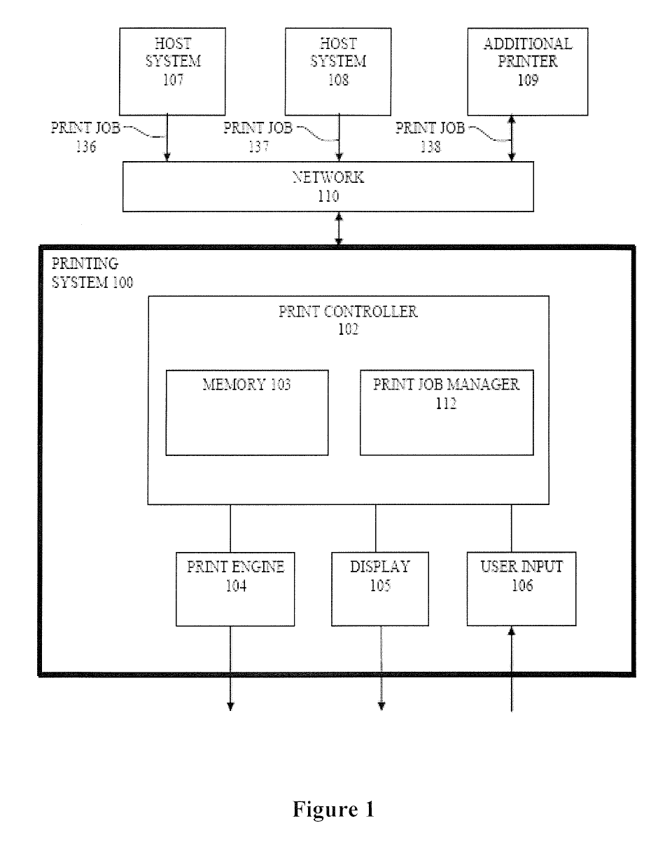

FIG. 1 is a block diagram illustrating one embodiment of a printing system 100. Printing system 100 is a system used to provide marks on a media, such as a continuous forms printer or a cut sheet page printer. Printing system 100 may include any digital hardcopy output device, such as printers, copiers, multifunction printers (MFP's) and facsimiles.

In one embodiment, printing system 100 is shared by multiple users. In such an embodiment, printing system 100 includes a print controller 102 and one or more print engines 104. Print controller 102 includes any system, server, or components operable to interface one or more host systems 107 and 108, and a printer 109, via network 110 with one or more print engines 104, and to control the printing of print jobs 136-138 received from the host systems 107 and 108, and a printer 109, respectively, on print engine 104. Print engine 104 provides an imaging process to mark a printable medium, such as paper.

According to one embodiment, print controller 102 includes memory 103 and a print job manager 112. Memory 103 includes any storage system operable to store data. In one embodiment, print job manager 112 manages the printing of documents at printing system 100. Particularly, print job manager 112 controls print jobs as they wait to print, arranges the priority of the jobs, generates separator pages and distributes print jobs to the destination print engine 104. In such an embodiment, print job manager 112 may be implemented using either InfoPrint Manager (IPM) or InfoPrint ProcessDirector (IPPD), although other types of print job managers may be used instead.

In one embodiment, print job manager 112 holds received print jobs in memory 103 before processing the print job. In such an embodiment, memory 103 stores the print jobs as either a data file or rastorized file. For example, print jobs stored as rastorized files reduce print time for the held jobs versus those stored as data files. Once stored, each print job may be held until a user that generated the print job retrieves the corresponding document from printing system 100, at which time the print job is processed and printed.

However in one embodiment, print job manager 112 uses criteria defined in printing system 100 to determine (on a per print job basis) processing actions to take on one or more print jobs and one or more conditions for such actions. Thus, print job manager 112 determines if a printing condition indicates that one or more print jobs are to be processed according to one or more processing actions.

In one such embodiment, a condition may be indicated by the print job data stream. Thus, print job manager 112 may analyze the print job data stream against criteria to determine if a print job is to be printed as a secure print job. Additionally, a condition may be indicated by information at printing system 100, resulting in print job manager 112 analyzing system information against criteria to determine if a print job is to undergo one or more processing actions.

Criteria are algorithms or rules that define an action (e.g., leave print job in memory, print job, delete job, etc) upon one or more conditions being met. The criteria are pre-defined before a print job is received and may be modified as desired. Additionally, criteria may include rules that act on one or more variables. The variables may include information values available to the printer system.

In one embodiment, a criteria variable is represented by available printer memory. For example, a print job is released for print if an amount of memory available at memory 103 is below a predefined limit. In such an embodiment, a method for selection of print jobs to be released is based on received order (e.g., first-in first-out (FIFO) or release of the largest print jobs).

Another criteria variable is represented by a time that a print job was received versus a present time. For example, a print job is released for print if the job has been held beyond a predefined time. Another example provides for a print job being deleted if a user has not deleted the job before a predefined time since receipt at the printer. Yet another criteria variable is represented by print job size. In such an embodiment, a print job is released for printing if its size exceeds a predefined limit of pages. The consideration in this embodiment is that it is preferable for large jobs not to be held.

User name may also represent a criteria variable. For example, print jobs from particular user names are enabled for immediate release, and not held indefinitely, since some users may have special needs that justify an exception. Another example may provide that a limit of up to 15 print jobs may be held for each user. If additional print jobs are received for the user, the oldest print job may be printed or deleted.

Print job classification (e.g., confidential, non-confidential, draft, final, urgent or not urgent) is another criteria variable. For example, if a print job is classified as confidential (e.g., through control characters or fields in the print job's header), the job will not be printed after a pre-defined hold time even though non-confidential jobs would be printed. User selection at printer is also a criteria variable. For example, users may select an action for a print job by making selections at user input 106.

User selection from a device web page may also be a criteria variable. For instance, users may select an action for a print job by making selections at a web page interface for printing system 100. Another criteria variable is represented by time coordinates (e.g., time, time zone, day, year, etc.). For example, criteria may be set so that no print jobs are printed without user selection on weekends.

Still another criteria variable is represented by machine state; where machine state includes consumable supplies condition, error messages, machine readiness, machine supplies availability, machine resource availability, machine settings, installed features, etc. For example, if one print job needs a printer resource that is unavailable, that print job is held awaiting correction of the printer resource or end user selection of a subsequent action. Other print jobs that have the needed printer resources available would be released for printing.

Another example includes deleting all held print jobs after the printer is powered off and back on. This may be accomplished by detection of the machine shut down process or detection of a recent power on state. Yet another example is to not delete print jobs that have been held beyond a predefined time limit since receipt at the printing system 100 if printing system 100 is in an error state.

Metadata (e.g., number of copies, duplex, n-up, file name, print queue name, etc.) may also be included as a criteria variable. For example, print jobs that exceed a set number of copies may be printed immediately rather than being held. Usage history may be a criteria variable as well. Usage history is a number of pages (overall or for a specific user) printed or copied on printing system 100. For example, print jobs of infrequent users may receive higher priority for release than frequent users in order to discourage excessive printing.

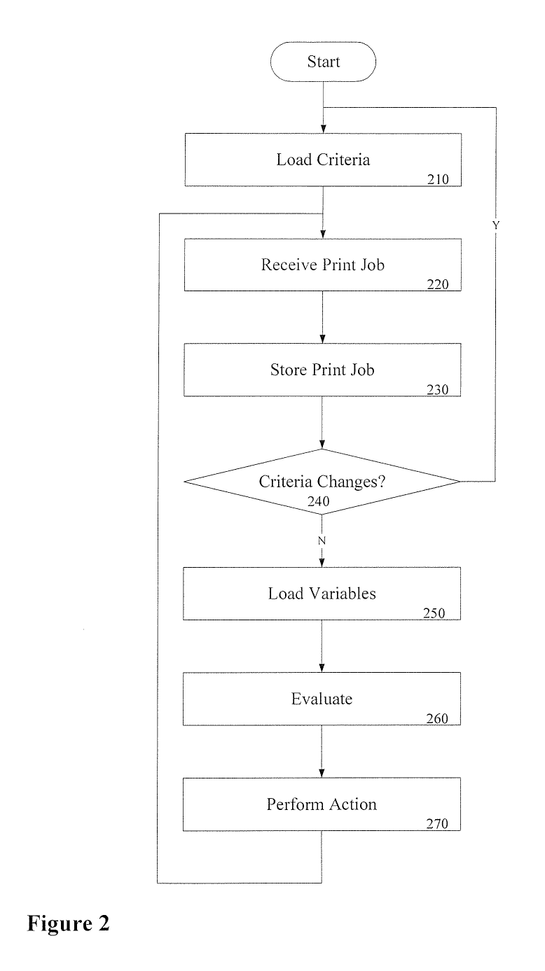

FIG. 2 is a flow diagram illustrating one embodiment of managing print jobs at printing system 100. At processing block 210, the criteria are loaded for which print job data stream and printing system 100 conditions are compared to determine if streams are received at print job manager 112. At processing block 230, the print jobs are stored at memory 103.

At decision block 240, it is determined whether there have been changes to the criteria. If so, control is returned to processing block 210 where the criteria changes are loaded. Otherwise the variables are loaded, processing block 250. At processing block 260, the criteria are evaluated against the variables for each stored print job. At processing block 270, various actions may be taken based on the evaluation. Subsequently, control is returned to processing block 220 where other print jobs are received.

As discussed above, the criteria specify one or more processing actions to be taken, and when, on the print jobs. The actions may include the following: leave print job in memory; placement of the print job in a print queue priority, print the job; delete the job from memory 103; forward the job to another printer 109; email the print job; or fax the print job.

According to one embodiment, all print jobs for the same user are printed together when multiple print jobs are released to print based on criteria. For example, it may be desirable for efficiency to print all of a particular user's print jobs when any one of their print jobs meets the criteria for release to print in order to batch the user's jobs. In another embodiment, a particular user's view of held print jobs may be sorted based on print job attributes, such as user name, time coordinates of receipt, job name, etc. For example, a user may view all held jobs in a list to facilitate the selection of jobs. Print job received date/time, job names, and size all assist a user decide what actions to take on the jobs.

According to one embodiment, printing system 100 may add a generated separator page to the batch of selected printed jobs. In another embodiment, a traditional separator page (e.g., one separator page per printed job) may be generated that refers to the individual user associated with print job. In another embodiment, no separator pages are added.

Control of a print job may be through printer control, host control or a combination of thereof. Combination of printer and host control may be implemented by a division of responsibility between the host and printer. For example, a print job includes specifications (such as defined control characters) for an expiration date/time as to when it is to be deleted from printing system 100.

In one embodiment, records of actions on print jobs at printing system 100 are stored and made available to a host or other devices through various protocols (e.g., SNMP, TCP/IP, FTP, HTTP, email, etc) using various channels (e.g. WAN, LAN, PC Serial, PC Parallel, IEEE1394, USB, 802.11x, MIB etc.). The records of actions may also be printed by the printing system 100, displayed on display 105 or available from an associated web page.

Further, the information recorded may be used for billing or confirmation, and include actions performed on the print job, print job information, time/date of the action, etc. For example: records may show that “Print Job 1234 deleted, Reason is job exceeded time held limit” or “Job 1234 deleted, Reason is User ABCD initiated deletion”.

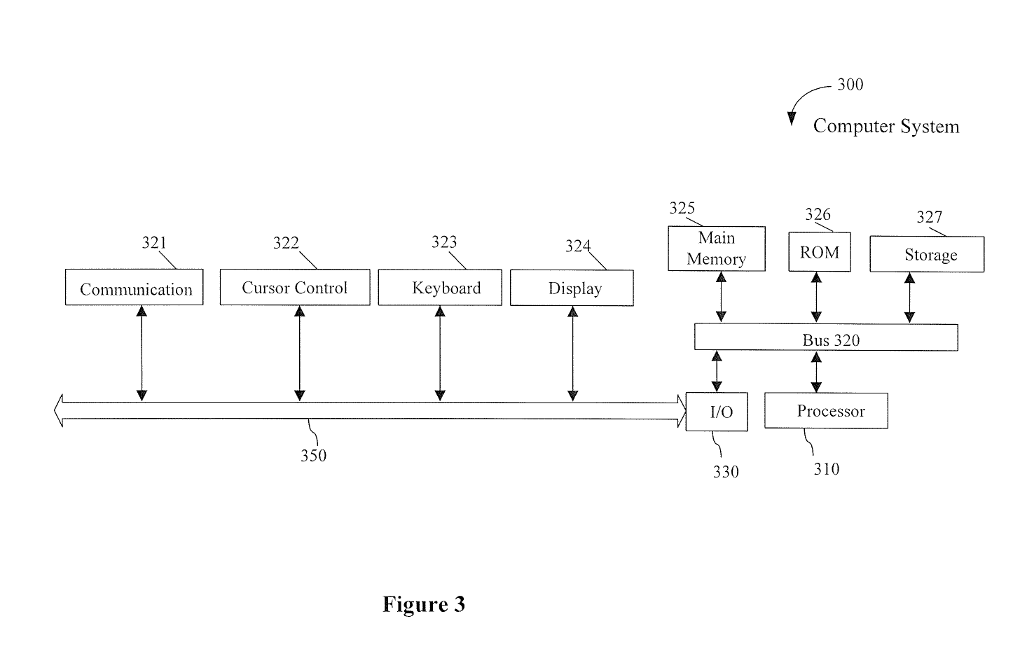

FIG. 3 illustrates a computer system 300 on which printing system 100 may be implemented. Computer system 300 includes a system bus 320 for communicating information, and a processor 310 coupled to bus 320 for processing information.

Computer system 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Computer system 300 also may include a read only memory (ROM) and or other static storage device 326 coupled to bus 320 for storing static information and instructions used by processor 310.

A data storage device 325 such as a magnetic disk or optical disc and its corresponding drive may also be coupled to computer system 300 for storing information and instructions. Computer system 300 can also be coupled to a second I/O bus 350 via an I/O interface 330. A plurality of I/O devices may be coupled to I/O bus 350, including a display device 324, an input device (e.g., an alphanumeric input device 323 and or a cursor control device 322). The communication device 321 is for accessing other computers (servers or clients). The communication device 321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printing system comprising:
a storage device; and
a print job manager to store received print jobs in the storage device, select one or more of the stored print jobs upon detecting an occurrence of a condition that matches one or more pre-defined criteria and performing a processing action indicated by the pre-defined criteria.

2. The printing system of claim 1 wherein the condition comprises system information that matches one or more of the pre-defined criteria.

3. The printing system of claim 2 wherein a criteria condition is an indication that storage space available at the storage device is below a predefined limit.

4. The printing system of claim 2 wherein a criteria condition is an indication that the one or more print jobs have been stored at the storage device in excess of a predefined time.

5. The printing system of claim 2 wherein a criteria condition is an indication that the one or more print jobs exceed a predefined size.

6. The printing system of claim 1 wherein the condition comprises a data stream object that matches one or more of the pre-defined criteria.

7. The printing system of claim 6 wherein a criteria condition is an object in the data stream indicating a predefined user name.

8. The printing system of claim 6 wherein a criteria condition is an object in the data stream indicating a print job classification.

9. The printing system of claim 2 wherein a criteria condition is an indication that the one or more print jobs have been selected for immediate processing.

10. The printing system of claim 1 wherein the processing action comprises printing the selected print jobs.

11. The printing system of claim 10 wherein the processing action comprises generating and printing a separator page for the selected print jobs.

12. The printing system of claim 1 wherein the processing action comprises deleting the selected print jobs.

13. The printing system of claim 1 wherein the processing action comprises emailing the selected print jobs.

14. A computer generated method comprising:
receiving a print job;
storing the print job data;
determining if a condition occurs during that matches one or more pre-defined criteria;
selecting the print job if the condition occurs; and
performing a processing action indicated by the pre-defined criteria.

15. The method of claim 14 further comprising loading the one or more pre-defined criteria.

16. The method of claim 14 wherein the condition comprises system information that matches one or more of the pre-defined criteria.

17. The method of claim 14 wherein the condition comprises a data stream object that matches one or more of the pre-defined criteria.

18. The method of claim 14 wherein performing the processing action comprises printing the print job.

19. The system of claim 1 wherein performing the processing action comprises deleting the selected print job.

20. An article of manufacture comprising a machine-readable medium including data that, when accessed by a machine, cause the machine to perform operations comprising:
receiving a print job;
storing the print job data;
determining if a condition occurs during that matches one or more pre-defined criteria;
selecting the print job if the condition occurs; and
performing a processing action indicated by the pre-defined criteria.
